(19) United States
(12) Patent Application Publication
(10) Pub. No.: US 2024/0005023 A1
(43) Pub. Date: Jan. 4, 2024

(54) SYSTEM AND METHOD FOR GENERATING ITEMS OF INVENTORY A USER CAN ACCESS BASED ON HIERARCHICAL PERMISSIONS

(71) Applicant: VMWARE, INC., Palo Alto, CA (US)

(72) Inventors: KALYAN DEVARAKONDA, Bangalore (IN); NARASIMHA GOPAL GORTHI, Bangalore (IN); JOHN E. BREZAK, Camano Island, WA (US); LOKESH SHRIVASTAVA, Bangalore (IN); NARASIMHA MURTHI, Bangalore (IN)

(21) Appl. No.: 17/901,903

(22) Filed: Sep. 2, 2022

(30) Foreign Application Priority Data
Jul. 2, 2022 (IN) 202241038214

(51) Int. Cl. G06F 16/23; G06Q 10/08; G06F 16/22

(52) U.S. Cl. CPC G06F 16/2358; G06Q 10/087; G06F 16/2246

(57) ABSTRACT

Items of inventory of a data center are organized in a hierarchical manner across nodes of at least one hierarchical tree. A method of generating items of inventory of the data center to which a user has access includes generating a plurality of first user access paths based on permissions given to the user at one or more nodes of a first hierarchical tree, and performing a database look-up on an inventory database using the first user access paths to determine the inventory items of the data center to which the user has access. The inventory database stores for each inventory item of the data center identifying information that uniquely identifies the inventory item and node information indicating the node of the first hierarchical tree where the inventory item is arranged.

### RELATED APPLICATIONS

Benefit is claimed under 35 U.S.C. 119(a)-(d) to Foreign Application Serial No. 202241038214 filed in India entitled “SYSTEM AND METHOD FOR GENERATING ITEMS OF INVENTORY A USER CAN ACCESS BASED ON HIERARCHICAL PERMISSIONS”, on Jul. 2, 2022, by VMware, Inc., which is herein incorporated in its entirety by reference for all purposes.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration between the hosts, distributed power management, dynamic VM placement according to affinity and anti-affinity rules, and high availability (HA). The management software also manages a shared storage device to provision storage resources for the cluster from the shared storage device, and a software-defined network through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

With a large number of SDDCs, managing the full inventory of a customer from a single pane of glass across all of the SDDCs of the customer has proven to be challenging. To be able to do so, the customer should be able view items in the inventory across all of the SDDCs, but rights to view the items in the inventory is governed by role-based access control and require computation of hierarchical permissions across a large number of inventory items.

### SUMMARY

One or more embodiment provide a method of generating items of inventory of a data center, e.g., SDDC, to which a user has access, wherein the items of inventory are organized in a hierarchical manner across nodes of at least one hierarchical tree. The method includes generating a plurality of first user access paths based on permissions given to the user at one or more nodes of a first hierarchical tree, and performing a database look-up on an inventory database using the first user access paths to determine the inventory items of the data center to which the user has access. The inventory database stores for each inventory item of the data center identifying information that uniquely identifies the inventory item and node information indicating the node of the first hierarchical tree where the inventory item is arranged.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a conceptual block diagram of customer environments of different organizations that are managed through a multi-tenant cloud platform.

FIG. 2 illustrates components of the multi-tenant cloud platform and an agent platform appliance that are involved in generating items of inventory or events to which a user has access, according to embodiments.

FIG. 3A illustrates an inventory hierarchy that is defined with respect to clusters.

FIG. 3B illustrates an inventory hierarchy that is defined with respect to folders.

FIG. 4 is a sample user interface for creating permissions for an item of inventory at a particular node of the inventory hierarchy.

FIG. 5 depicts a sequence of steps that are carried out in response to a user request to view items of inventory or events, according to embodiments.

FIGS. 6A and 6B are sample files containing user access paths.

FIG. 7 is a flow diagram that illustrates the steps of a method for computing user access paths, according to embodiments.

### DETAILED DESCRIPTION

One or more embodiments provide a cloud platform from which various services, referred to herein as “cloud services” are delivered to the SDDCs through agents of the cloud services that are running in an appliance (referred to herein as a “agent platform appliance”). The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine, and the two are connected over a public network, such as the Internet. In addition, the agent platform appliance and the management appliances are connected to each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the respective agents of the cloud services.

The cloud platform according to one or more embodiments also includes an authorization service that is responsible for computing the effective permissions of a logged-in user across all SDDCs of the customer by identifying the paths of the inventory hierarchy where the user has access or should be denied access. When the user requests a list of certain items in the inventory, e.g., virtual machines, across all SDDCs, or events relating to such items, the inventory service or the events service performs a look-up of its respective database for the requested items of inventory or events using the paths of the inventory hierarchy where the user has access or should be denied access.

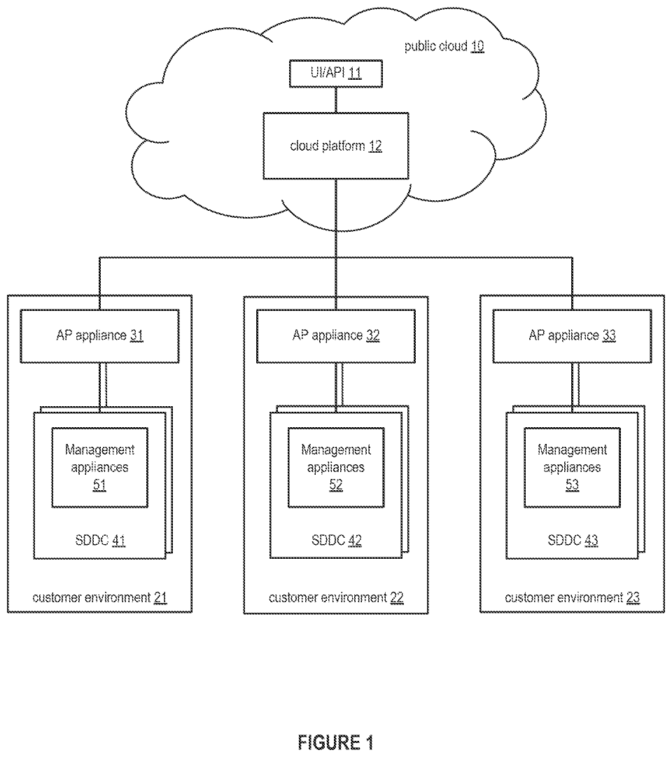

FIG. 1 is a conceptual block diagram of customer environments of different organizations (hereinafter also referred to as “customers” or “tenants”) that are managed through a multi-tenant cloud platform 12, which is implemented in a public cloud 10. A user interface (UI) or an application programming interface (API) of cloud platform 12 is depicted in FIG. 1 as UI/API 11. The computing environment illustrated in FIG. 1 is sometimes referred to as a hybrid cloud environment because it includes a public cloud 10 and a customer environment (e.g., customer environment 21, 22, or 23).

A plurality of SDDCs is depicted in FIG. 1 in each of customer environment 21, customer environment 22, and customer environment 23. In each customer environment, the SDDCs are managed by respective management appliances, which include a virtual infrastructure management (VIM) server appliance (e.g., the VMware vCenter Server® appliance) for overall management of the virtual infrastructure, and a network management server appliance (e.g., the VMware NSX® appliance) for management of the virtual networks. For example, SDDC 41 of the first customer is managed by management appliances 51, SDDC 42 of the second customer by management appliances 52, and SDDC 43 of the third customer by management appliances 53.

The management appliances in each customer environment communicate with an agent platform appliance, which hosts agents that communicate with cloud platform 12 to deliver cloud services to the corresponding customer environment. The communication is over a local area network of the customer environment where the agent platform appliance is deployed. For example, management appliances 51 in customer environment 21 communicate with agent platform appliance 31 over a local area network of customer environment 21. Similarly, management appliances 52 in customer environment 22 communicate with agent platform appliance 32 over a local area network of customer environment 22, and management appliances 53 in customer environment 23 communicate with agent platform appliance 33 over a local area network of customer environment 23.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments, each of the agent platform appliances and the management appliances is a VM instantiated on one or more physical host computers having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, any of the agent platform appliances and the management appliances may be implemented as a physical host computer having the conventional hardware platform described above.

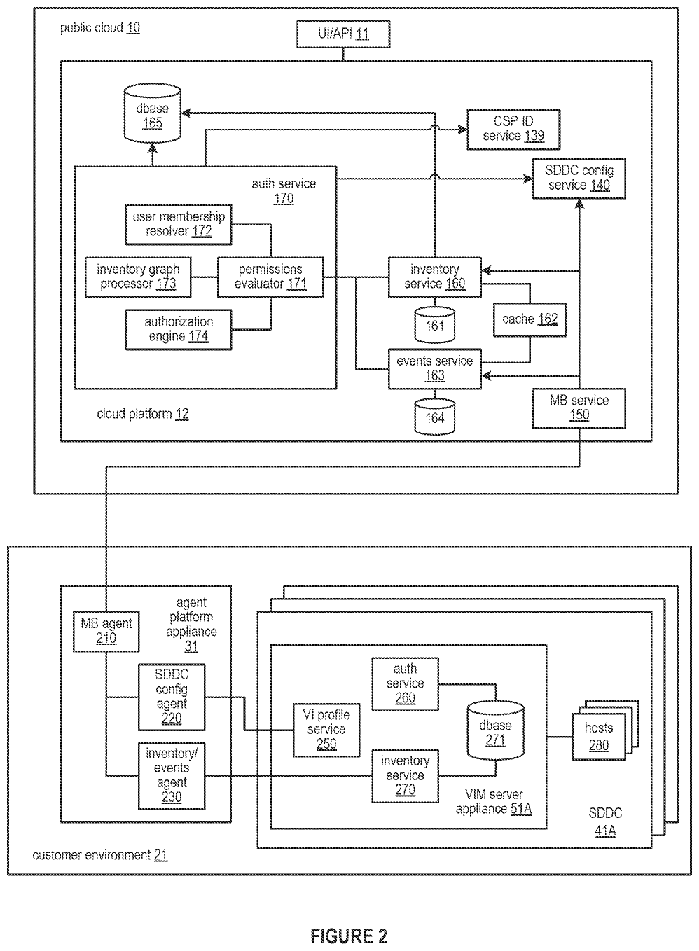

FIG. 2 illustrates components of cloud platform 12 and agent platform appliance 31 that are involved in generating the items of inventory or events to which a user has access, according to embodiments. Cloud platform 12 is accessible by different customers through UI/API 11 and each of the different customers manage its full inventory across its group of SDDCs through cloud platform 12. In FIG. 2, the management of the inventory of the SDDCs in customer environment 21, in particular that of SDDC 41A, is selected for illustration. It should be understood that the description given herein for customer environment 21 also apply to other customer environments, including customer environment 22 and customer environment 23.

Cloud platform 12 includes a group of cloud services running in virtual infrastructure of public cloud 10 through which a customer can manage its full inventory across its group of SDDCs by issuing commands through UI/API 11. In the embodiments described herein, each of these cloud services is a microservice that is implemented as one or more container images executed on a virtual infrastructure of public cloud 10.

Cloud services provider (CSP) ID service 139 manages authentication of access to cloud platform 12 through UI/API 11. CSP ID service 139 also maintains group membership information that indicates what users belong to which groups.

SDDC configuration service 140 is responsible for accepting commands made through UI/API 11 and dispatching tasks to a particular customer environment through message broker (MB) service 150 to apply the desired state to the SDDCs. SDDC configuration service 140 is also responsible for processing changes to the desired state reported by the SDDCs, updating the desired state, and dispatching tasks to the SDDCs to apply the updated desired state to the SDDCs.

Inventory service 160 is responsible for tracking items in the full inventory of the SDDCs of each customer, and for each item of inventory, stores identifying information (e.g., name and/or ID), and node information indicating the node of the inventory hierarchy where it is arranged, in inventory database 161. In the embodiments where items of inventory are arranged in nodes of different inventory hierarchies, multiple node information is stored per each item of inventory.

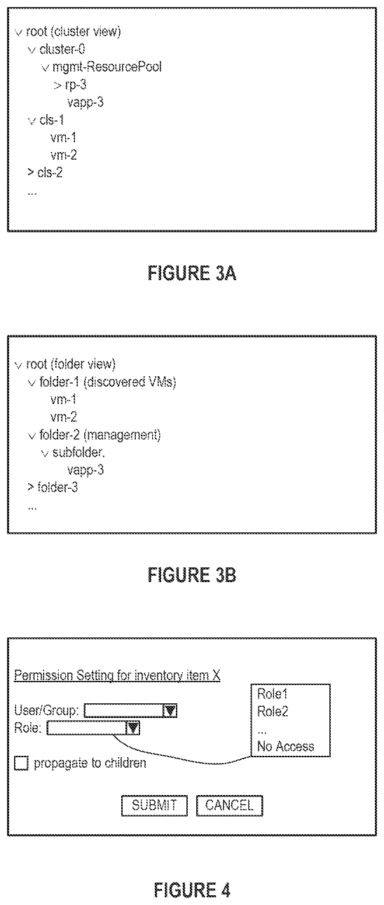

For example, the inventory hierarchy may be defined with respect to clusters as depicted in FIG. 3A. The different clusters depicted in FIG. 3A are cluster-0, cls-1, and cls-2, and these clusters are child nodes of the root node, and each of the cluster nodes may have one or more child nodes and/or leaf nodes. The VMs identified as vm-1 and vm-2 are leaf nodes of the cluster node, cls-1.

In FIG. 3B, the inventory hierarchy is defined with respect to folders, namely folder-1, which is a folder of discovered VMs, folder-2, which is a management folder, and folder-3. Each of the folders is a child node of the root node, and each of the folder nodes may have one or more child nodes and/or leaf nodes. The VMs identified as vm-1 and vm-2 are leaf nodes of the folder node, folder-1. In the embodiments illustrated herein, the VMs identified as vm-1 and vm-2 belong to both the cluster-view inventory hierarchy of FIG. 3A and the folder-view inventory hierarchy of FIG. 3B.

In the embodiments, inventory service 160 also tracks permissions that are created in the different SDDCs through an authorization service running in the management appliances (e.g., authorization service 260 running in VIM server appliance 51A). FIG. 4 is a sample user interface for creating permissions for an item of inventory at a particular node of either the cluster-view inventory hierarchy or the folder-view inventory hierarchy. A permission for the item of inventory at the particular node is created by selecting a user or a group (which is predefined set of users) against a role (which is a predefined set of one or more privileges). In the embodiments, all roles except for the “No Access” role include a viewing privilege. A “No Access” role is selected when the selected user or group is to be denied any access to the item of inventory at the particular node.

The checkbox for “propagate to children” allows the permission created for an inventory item at any node to be propagated to all child nodes and other nodes, such as grandchildren nodes and leaf nodes, that are descendant nodes. When this checkbox is checked when creating the permission for the root node of the inventory hierarchy (either the cluster-view inventory hierarchy or the folder-view inventory hierarchy), a global permission is created for entire inventory hierarchy.

The permissions created in the above manner in each of the SDDCs are reported to inventory service 160 and inventory service 160 stores these permission in a database 165. Each entry of the permissions in database 165 includes the following attributes: identifying information of the inventory hierarchy, node information of the item of inventory for which the permission is created, and the permission (which is defined as a user or group against a particular role).

Events service 163 is responsible for tracking events relating to different items of the full inventory reported by the SDDCs, and for each event, stores identifying information (e.g., name and/or ID), and the item of inventory to which it relates (e.g., name or ID of the item of inventory), in events database 164.

Authorization service 170 is responsible for identifying the paths of the inventory hierarchy where the user has access or should be denied access. It includes the following software modules: permission evaluator 171, user membership resolver 172, inventory graph processor 173, and authorization engine 174. Permission evaluator 171 is the endpoint of authorization service 170 that exposes application programming interfaces (APIs) for other services of cloud platform 12 to consume. User membership resolver 172 is responsible for identifying all the groups that the user belongs to by issuing an API to CSP ID service 139, and for acquiring VIM server appliance group information from SDDC configuration service 140. VIM server appliance group information is maintained by SDDC configuration service 140 for each VIM server appliance and indicates what users and groups are permitted access to that VIM server appliance. The permissions are applied at both the individual level and the group level, and so the group information is needed for proper permission evaluation. Inventory graph processor 173 is responsible for constructing an inventory graph for each SDDC that is registered with cloud platform 12. Inventory graph processor 173 updates the inventory graph of any SDDC when it receives reports of inventory topology changes from that SDDC. Authorization engine 174 runs the core algorithm to compute the paths of the inventory hierarchy where the user has access or should be denied access. The inventory graph constructed and maintained by inventory graph processor 173 is used when authorization engine 174 traverses the inventory hierarchy to compute the paths of the inventory hierarchy where the user has access or should be denied access.

MB service 150 is responsible for exchanging messages with message broker (MB) agents deployed in different customer environments upon receiving a request to exchange messages from the MB agents. The communication between MB service 150 and the different MB agents is, for example, over a public network such as the Internet. MB service 150 also routes messages to the cloud services running on cloud platform 12. For example, messages containing changes to the inventory, inventory graph, and permissions are routed to inventory service 160 and messages containing events are routed to events service 163.

Agent platform appliance 31 in customer environment 21 has various agents of cloud services running in cloud platform 12 deployed thereon. In the embodiments described herein, each of the agents and services deployed on the agent platform appliances is a microservice that is implemented as one or more container images executing in the agent platform appliances.

The three agents depicted in FIG. 2 include MB agent 210, SDDC configuration agent 220, and inventory/events agent 230. MB agent 210 periodically polls MB service 150 to exchange messages with MB service 150, i.e., to receive messages from MB service 150 and to transmit to MB service 150 messages that it received from other agents deployed in agent platform appliance 31. If a message received from MB service 150 includes a task to apply the desired state, MB agent 210 routes the message to SDDC configuration agent 220. In the other direction, messages containing changes to the inventory, inventory graph, and permissions, and events that are received from inventory/events agent 230 are transmitted to MB service 150 during the next message exchange with MB service 150.

SDDC configuration agent 220 functions as a communication bridge between SDDC configuration service 140 running on cloud platform 12 and configuration services running in the management appliances of the SDDCs that are deployed in the same customer environment as SDDC configuration agent 220, for example, virtual infrastructure (VI) profile service 250 running in VIM server appliance 51A. When SDDC configuration agent 220 receives a task to apply the desired state, it calls an API of VI profile service 250 to execute the task. In the other direction, VI profile service 250 reports any drift from the desired state to SDDC configuration agent 220 and SDDC configuration agent 220 reports any such drift to SDDC configuration service 140 through MB agent 210 and MB service 150.

Similarly, inventory/events agent 230 functions as a communication bridge between inventory service 160 and events service 163 running on cloud platform 12 and inventory services running in the management appliances of the SDDCs that are deployed in the same customer environment as SDDC configuration agent 220, for example, inventory service 270 running in VIM server appliance 51A. When inventory service 270 detects changes to the inventory, inventory graph, and permissions, or certain events that it has subscribed to (e.g., error events), inventory service 270 transmits such changes/events to inventory/events agent 230, and inventory/events agent 230 reports any such changes/events to inventory service 160 and events service 163 through MB agent 210 and MB service 150.

In FIG. 2, VIM server appliance 51A manages SDDC 41A and the inventory of SDDC 41A, which includes VMs, virtual applications, and resource pools of virtual infrastructure provisioned from a cluster of hosts 280. In addition to VI profile service 250 and inventory service 270 described above, VIM server appliance 51A also has running therein an authorization service 260, which is responsible for updating permissions saved in permissions database 271 when permissions are created for an item of inventory, e.g., through the user interface shown in FIG. 4.

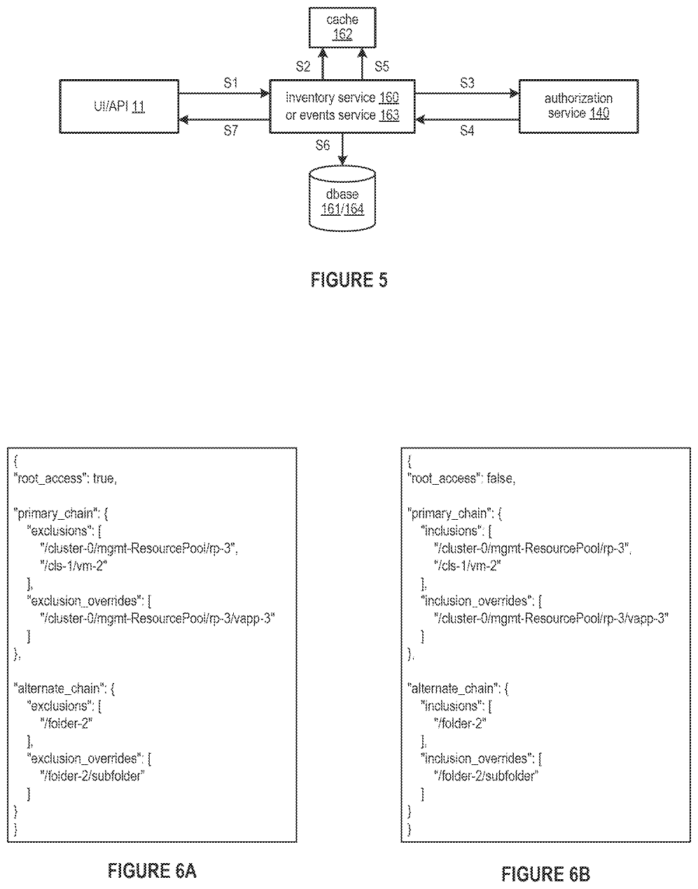

FIG. 5 depicts a sequence of steps that are carried out in response to a user request to view items of inventory or events, according to embodiments. Step S1 represents the user request made through UI/API 11. In response to the user request to view items of inventory (or events), inventory service 160 (or events service 163) at step S2 checks cache 162 to determine if paths of the inventory hierarchy where the user has access or should be denied access have been computed. Hereinafter, these paths are referred to as “user access paths” and two sample files of user access paths for a particular user are depicted in FIGS. 6A and 6B.

According to the user access paths depicted in FIG. 6A, the user has global permission to view the items of inventory, as indicated by “root_access”: true, and exclusions to the global permission are defined by listing paths of the inventory hierarchy where the user should be denied access under “exclusions.” The excluded paths may be overridden by specifying paths under “exclusion_overrides.” In the example given in FIG. 6A, the path “/cluster-0/mgmt-ResourcePool/rp-3” is excluded from the global permission and so the user does not have permission to view items of inventory that are at a node in the inventory hierarchy containing the path “/cluster-0/mgmt-ResourcePool/rp-3.” However, the user does have permission to view items of inventory that are at a node in the inventory hierarchy containing the path “/cluster-0/mgmt-ResourcePool/rp-3/vapp-3.” In addition, the user access paths may be specified for the “primary_chain” or the “alternate_chain.” The “primary_chain” represents user access paths defined according to the cluster-view inventory hierarchy. The “alternate_chain” represents user access paths defined according to the folder-view inventory hierarchy.

According to the user access paths depicted in FIG. 6B, the user does not have global permission to view the items of inventory, as indicated by “root_access”: false. Any permissions that the user does have to view the items of inventory are reflected by paths of the inventory hierarchy that are listed under “inclusions.” The included paths may be overridden by specifying paths under “inclusion_overrides.” In the example given in FIG. 6B, the path “/cluster-0/mgmt-ResourcePool/rp-3” is an included path and so the user has permission to view items of inventory that are at a node in the inventory hierarchy containing the path “/cluster-0/mgmt-ResourcePool/rp-3.” However, the user does not have permission to view items of inventory that are at a node in the inventory hierarchy containing the path “/cluster-0/mgmt-ResourcePool/rp-3/vapp-3,” because this path is specified under “inclusion_overrides.”

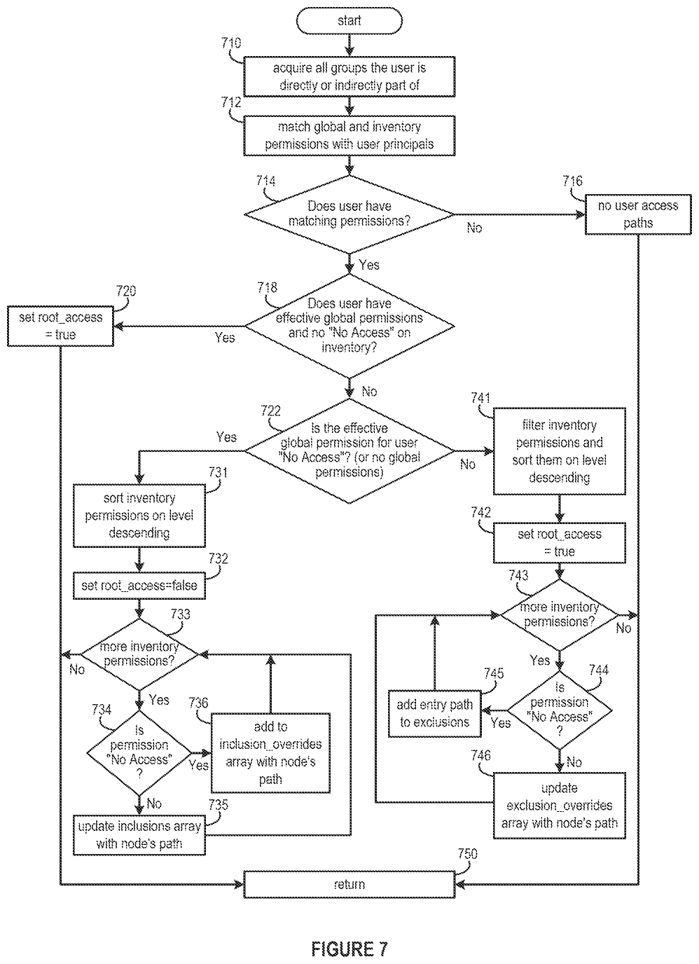

Returning to FIG. 5, if the user access paths have not been computed, inventory service 160 (or events service 163) at step S3 calls an API of authorization service 140 to compute the user access paths. In response, authorization service 170 executes the flow diagram of FIG. 7 and at step S4 returns the computed user access paths to inventory service 160 (or events service 163), which at step S5 stores the computed user access paths in cache 162. Then, at step S6, inventory service 160 (or events service 163) performs a database look-up on inventory database 161 (or events database 164) using the computed user access paths. The result of the database look-up, namely the items of inventory to which the user has access (or events relating to the items of inventory to which the user has access), is returned at step S7 to the user.

On the other hand, if the user access paths have been computed, steps S3, S4, and S5 do not need to be executed, and inventory service 160 (or events service 163) retrieves the user access paths from cache 162 and at step S6 performs a database look-up on inventory database 161 (or events database 164) using the retrieved user access paths. Thereafter, the result of the database look-up, namely the items of inventory to which the user has access (or events relating to the items of inventory to which the user has access), is returned at step S7 to the user.

In the embodiments, steps S3, S4, and S5 are also carried out by inventory service 160 in response to any changes in the permissions reported through MB service 150. The changes are first stored in database 165 by inventory service 160. Then, at step S3, inventory service 160 calls an API of authorization service 170 to compute the user access paths. In response, authorization service 170 executes the flow diagram of FIG. 7, and at step S4 returns the computed user access paths to inventory service 160, which at step S5 stores the computed user access paths in cache 162.

FIG. 7 is a flow diagram that illustrates the steps of a method for computing user access paths, according to embodiments. This method is carried out by authorization service 170 in response to an API call from inventory service 160. The method of FIG. 7 begins at step 710 at which user membership resolver 172 acquires all groups of the user. Then, at step 712, authorization engine 174 queries database 165 for all permissions for the user and the groups of the user. If there are no matching permissions (step 714; No), authorization service 170 at step 716 determines that there are no user access paths and notifies inventory service 160 of the same at step 750. If there are matching permissions, the method continues to step 718.

At step 718, authorization engine 174 checks the permissions to determine if they are any global permission with no “No Access” permissions. If so, authorization engine 174 sets “root_access” to true at step 720 and returns a file with a single entry of “root_access”: true to inventory service 160. If there are no global permission or any of the global permissions have “No Access” permissions, then step 722 is executed.

At step 722, authorization engine 174 evaluates whether there are any global permission with no “No Access” permissions. If so, steps 731-736 are executed for each of the inventory hierarchy (e.g., cluster-view inventory hierarchy and folder-view inventory hierarchy). If not, steps 741-746 are executed for each of the inventory hierarchy (e.g., cluster-view inventory hierarchy and folder-view inventory hierarchy).

At step 731, authorization engine 174 sorts the permissions on level descending in accordance with the inventory hierarchy. Then, authorization engine 174 sets “root_access” to false in a file containing user access paths at step 732. Steps 733-736 are then executed for each of the sorted permissions in level descending order. If all permissions have been processed, the file containing the user access paths are returned at step 750. If not, authorization engine 174 at step 734 checks the permission to determine if it is a “No Access” permission. If it is not (step 734; No), the path to the node corresponding to the permission is added to the “inclusion” array of the user access paths (step 735). If it is (step 734; Yes), the path to the node corresponding to the permission is added to the “inclusion_overrides” array of the user access paths (step 736).

At step 741, authorization engine 174 filters the permissions to remove duplicates, e.g., permissions that overlap with global permission. In other words, only the “No Access” permissions and the permissions that override the “No Access” permissions are retained and then the retained permissions are sorted on level descending in accordance with the inventory hierarchy. Then, authorization engine 174 sets “root_access” to true in a file containing user access paths at step 742. Steps 743-746 are then executed for each of the sorted permissions in level descending order. If all permissions have been processed, the file containing the user access paths are returned at step 750. If not, authorization engine 174 at step 744 checks the permission to determine if it is a “No Access” permission. If it is (step 744; Yes), the path to the node corresponding to the permission is added to the “exclusion” array of the user access paths (step 745). If it is not (step 744; No), the path to the node corresponding to the permission is added to the “exclusion_overrides” array of the user access paths (step 746).

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of generating items of inventory of a data center to which a user has access, wherein the items of inventory are organized in a hierarchical manner across nodes of at least one hierarchical tree, said method comprising:
generating a plurality of first user access paths based on permissions given to the user at one or more nodes of a first hierarchical tree; and
performing a database look-up on an inventory database using the first user access paths to determine inventory items of the data center to which the user has access,
wherein the inventory database stores for each inventory item of the data center identifying information that uniquely identifies the inventory item and node information indicating the node of the first hierarchical tree where the inventory item is arranged.

2. The method of claim 1, further comprising:
after generating the plurality of first user access paths, storing the plurality of first user access paths in a cache; and
prior to performing the database look-up, retrieving the plurality of first user access paths from the cache.

3. The method of claim 2, further comprising:
after storing the plurality of first user access paths in the cache, detecting that the inventory has changed;
updating the inventory database to apply the detected changes to the inventory; and
after updating the inventory database, performing another database look-up on the updated inventory database using the first user access paths retrieved from the cache.

4. The method of claim 2, further comprising:
detecting that the permissions given to the user have changed;
re-generating the plurality of first user access paths based on the changed permissions; and
performing another database look-up on the inventory database using the first user access paths that have been re-generated.

5. The method of claim 1, wherein
the first user access paths specify first excluded access paths and overrides to the first excluded access paths, and the node information of each inventory item specifies an access path thereto, and
an inventory item is determined to be accessible by the user if the access path to the inventory item does not contain any of the first excluded access paths, or if the access path to the inventory item contains any of the first excluded access paths and any of the overrides to the first excluded access paths.

6. The method of claim 1, wherein
the first user access paths specify first included access paths and overrides to the first included access paths, and the node information of each inventory item specifies an access path thereto, and
an inventory item is determined to be accessible by the user if the access path to the inventory item contains any of the first included access paths and does not contain any of the overrides to the first included access paths.

7. The method of claim 1, further comprising:
generating a plurality of second user access paths based on permissions given to the user at one or more nodes of a second hierarchical tree,
wherein the database look-up is performed on the inventory database using the first user access paths and the second user access paths.

8. The method of claim 7, wherein
an inventory item is determined to be accessible by the user when the database look-up performed on the inventory database using either the first user access paths or the second user access paths indicates that the user has permission to access the inventory item.

9. A non-transitory computer readable medium comprising instructions that are executable on a processor to carry out a method of generating items of inventory of a data center to which a user has access, wherein the items of inventory are organized in a hierarchical manner across nodes of at least one hierarchical tree, said method comprising:
generating a plurality of first user access paths based on permissions given to the user at one or more nodes of a first hierarchical tree; and
performing a database look-up on an inventory database using the first user access paths to determine inventory items of the data center to which the user has access,
wherein the inventory database stores for each inventory item of the data center identifying information that uniquely identifies the inventory item and node information indicating the node of the first hierarchical tree where the inventory item is arranged.

10. The non-transitory computer readable medium of claim 9, wherein the method further comprises:
after generating the plurality of first user access paths, storing the plurality of first user access paths in a cache; and
prior to performing the database look-up, retrieving the plurality of first user access paths from the cache.

11. The non-transitory computer readable medium of claim 10, wherein the method further comprises:
after storing the plurality of first user access paths in the cache, detecting that the inventory has changed;
updating the inventory database to apply the detected changes to the inventory; and
after updating the inventory database, performing another database look-up on the updated inventory database using the first user access paths retrieved from the cache.

12. The non-transitory computer readable medium of claim 10, wherein the method further comprises:
detecting that the permissions given to the user have changed;
re-generating the plurality of first user access paths based on the changed permissions; and
performing another database look-up on the inventory database using the first user access paths that have been re-generated.

13. The non-transitory computer readable medium of claim 9, wherein
the first user access paths specify first excluded access paths and overrides to the first excluded access paths, and the node information of each inventory item specifies an access path thereto, and
an inventory item is determined to be accessible by the user if the access path to the inventory item does not contain any of the first excluded access paths, or if the access path to the inventory item contains any of the first excluded access paths and any of the overrides to the first excluded access paths.

14. The non-transitory computer readable medium of claim 9, wherein
the first user access paths specify first included access paths and overrides to the first included access paths, and the node information of each inventory item specifies an access path thereto, and
an inventory item is determined to be accessible by the user if the access path to the inventory item contains any of the first included access paths and does not contain any of the overrides to the first included access paths.

15. The non-transitory computer readable medium of claim 9, wherein the method further comprises:
generating a plurality of second user access paths based on permissions given to the user at one or more nodes of a second hierarchical tree,
wherein the database look-up is performed on the inventory database using the first user access paths and the second user access paths.

16. The non-transitory computer readable medium of claim 15, wherein
an inventory item is determined to be accessible by the user when the database look-up performed on the inventory database using either the first user access paths or the second user access paths indicates that the user has permission to access the inventory item.

17. A cloud platform for generating items of inventory of a data center to which a user has access, wherein the items of inventory are organized in a hierarchical manner across nodes of at least one hierarchical tree, and the cloud platform is programmed to carry out the steps of:
generating a plurality of first user access paths based on permissions given to the user at one or more nodes of a first hierarchical tree; and
performing a database look-up on an inventory database using the first user access paths to determine inventory items of the data center to which the user has access,
wherein the inventory database stores for each inventory item of the data center identifying information that uniquely identifies the inventory item and node information indicating the node of the first hierarchical tree where the inventory item is arranged.

18. The cloud platform of claim 17, wherein the steps further comprise:
after generating the plurality of first user access paths, storing the plurality of first user access paths in a cache; and
prior to performing the database look-up, retrieving the plurality of first user access paths from the cache.

19. The cloud platform of claim 18, wherein the steps further comprise:
after storing the plurality of first user access paths in the cache, detecting that the inventory has changed;
updating the inventory database to apply the detected changes to the inventory; and
after updating the inventory database, performing another database look-up on the updated inventory database using the first user access paths retrieved from the cache.

20. The cloud platform of claim 18, wherein the steps further comprise:
detecting that the permissions given to the user have changed;
re-generating the plurality of first user access paths based on the changed permissions; and
performing another database look-up on the inventory database using the first user access paths that have been re-generated.
